(19) United States
(12) Patent Application Publication
(10) Pub. No.: US 2026/0291826 A1
(43) Pub. Date: Sep. 24, 2026

(54) METHOD AND APPARATUS FOR AI/ML DATA TRANSMISSION IN A WIRELESS COMMUNICATION SYSTEM

(71) Applicant: SAMSUNG ELECTRONICS CO., LTD., Suwon-si, Gyeonggi-do (KR)

(72) Inventors: Morteza KHEIRKHAH, Staines, Middlesex (GB); David GUTIERREZ ESTEVEZ, Staines, Middlesex (GB); Chadi KHIRALLAH, Staines, Middlesex (GB)

(21) Appl. No.: 19/472,067

(22) PCT Filed: Mar. 28, 2024
(86) PCT No.: PCT/KR2024/003988

§ 371 Date: Oct. 2, 2025

(30) Foreign Application Priority Data
Apr. 6, 2023 (GB) 2305221.0
Mar. 5, 2024 (GB) 2403214.6

(51) Int. Cl. H04L 41/16; H04L 69/322

(52) U.S. Cl. CPC H04L 41/16; H04L 69/322

(57) ABSTRACT

The disclosure relates to a 5G or 6G communication system for supporting a higher data transmission rate. According to an example of the present disclosure, there is provided a first network entity comprising a first artificial intelligence (AI)/machine learning (ML) data transfer function. The first network entity is included in a network and comprises: a transmitter; a receiver; and at least one processor configured to: establish a first connection between the first AI/ML data transfer function and at least one second AI/ML data transfer function included in the network; and control the first AI/ML data transfer function to coordinate communicating AI/ML data with the network over user plane (UP) or control plane (CP) based on at least one rule or policy, wherein the AI/ML data relates to an AI/ML operation; wherein each of the at least one second AI/ML data transfer function is included in a second network entity. Also disclosed herein are examples of methods of a first network entity.

### TECHNICAL FIELD

The present disclosure relate to methods, apparatus and/or systems for transferring (e.g., delivering and/or collecting) AI (artificial intelligence)/ML (machine learning) related data in a network. Various examples provide methods, apparatus and/or systems wherein a new network function is provided in one or more network entities, with this network function being responsible for delivering AI/ML models and/or related data, and optionally for collecting data for AI/ML purposes also. In various examples, the new network function is a AI data delivery function provided in a UE and in a user plane function (and, optionally, in a RAN) to provide AI/ML related data to the UE over the UP.

### BACKGROUND ART

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The present disclosure relate to methods, apparatus and/or systems for transferring (e.g., delivering and/or collecting) AI (artificial intelligence)/ML (machine learning) related data in a network. Various examples provide methods, apparatus and/or systems wherein a new network function is provided in one or more network entities, with this network function being responsible for delivering AI/ML models and/or related data, and optionally for collecting data for AI/ML purposes also. In various examples, the new network function is a AI data delivery function provided in a UE and in a user plane function (and, optionally, in a RAN) to provide AI/ML related data to the UE over the UP.

### Solution to Problem

According to a first aspect of the present invention, there is provided a first network entity comprising a first artificial intelligence (AI)/machine learning (ML) data transfer function, wherein the first network entity is included in a network and comprises: a transmitter; a receiver; and at least one processor configured to: establish a first connection between the first AI/ML data transfer function and at least one second AI/ML data transfer function included in the network; and control the first AI/ML data transfer function to coordinate communicating AI/ML data with the network over user plane (UP) or control plane (CP) based on at least one rule or policy, wherein the AI/ML data relates to an AI/ML operation; wherein each of the at least one second AI/ML data transfer function is included in a second network entity.

According to various examples, the first AI/ML data transfer function is configured to control transfer of the AI/ML data over the UP or the CP based on data characteristics of the AI/ML data.

According to various examples, the first AI/ML data transfer function is connected to the at least one second AI/ML data transfer function via at least one existing or new protocol data unit (PDU) session.

According to various examples, the first connection is between the first AI/ML data transfer function and a plurality of the second AI/ML data transfer functions; and wherein the at least one processor is configured to: determine at least one transport protocol for use in establishing the first connection based on at least one of: a type of the AI/ML data, priority of the AI/ML, reliability and security of the transport protocol or available access in the case of multi-access scenarios; or receive, from the network, an indication of the at least one transport protocol.

According to various examples, one instance is used in the first connection for connecting the first AI/ML data transfer function to the plurality of second AI/ML data transfer functions or to a subset of the plurality of second AI/ML data transfer functions, over the at least one transport protocol.

According to various examples, the at least one transport protocol comprises a plurality of transport protocols; and wherein the first AI/ML data transfer function is configured to simultaneously use multiple transport sessions, using the plurality of transport protocols, for coordinating communication of the AI/ML data.

According to various examples, different transport protocols among the plurality of transport protocols are used for communicating different types of AI/ML data.

According to various examples, the first network entity is a user equipment (UE).

According to various examples (e.g. such as when the first network entity is a UE), the at least one processor is configured to: control the first AI/ML data transfer function to coordinate collection of at least a first portion of the AI/ML data; and transmit the first portion of the AI/ML data to the at least one second network entity based on the first connection.

According to various examples (e.g. such as when the first network entity is a UE), the at least one processor is configured to: transmit, to a core network (CN) during initial UE registration in the network, an indication that the first network entity includes the first AI/ML data transfer function or supports the first AI/ML data transfer function; and/or receive, from the CN, a PDU related message indicating that a PDU session corresponding to the PDU related message supports the first AI/ML data transfer function, wherein the PDU related message comprises an IP address of the at least one second AI/ML data transfer function; and wherein the at least one existing or new PDU session is the indicated PDU session.

According to various examples (e.g. such as when the first network entity is a UE), the at least one rule or policy are received from the network and indicates: how measurements are to be configured at the first network entity, data to be collected by the first network entity and the frequency of the collection of the data, how at least a second portion of the AI/ML data is to be communicated by the first network entity, and/or a PDU session to be used for the AI/ML data, wherein the at least one existing or new PDU session is the indicated PDU session.

According to various examples (e.g. such as when the first network entity is a UE), the at least one rule or policy indicates how to transmit the second portion of the AI/ML data based on one or more of a size of the AI/ML data, a type of the AI/ML data, a priority of the AI/ML data, or privacy of the AI/ML data.

According to various examples (e.g. such as when the first network entity is a UE), the at least one rule or policy indicates: how the AI/ML data is to be communicated, a priority for communicating the AI/ML data, and/or, if the at least one rule or policy comprises a plurality of different rules or policies, a relative priority between the plurality of different rules or policies.

According to various examples (e.g. such as when the first network entity is a UE), the at least one rule or policy is received from the network; and/or wherein the at least one rule or policy indicates, for each of a plurality of different network conditions, how the AI/ML data is to be communicated and/or the priority for communicating the AI/ML data.

According to various examples (e.g. such as when the first network entity is a UE), the at least one rule or policy comprises the plurality of different rules or policies, and the plurality of different rules or policies originate from a plurality of different entities within the network; and wherein the relative priority between the plurality of different rules or policies indicates whether a rule or policy, among the plurality of different rules or policies, originating from one of the plurality of different entities can be prioritised over another rule or policy, among the plurality of different rules or policies, originating from a different one of the plurality of different entities.

According to various examples (e.g. such as when the first network entity is a UE), the at least one processor is configured to: receive at least a third portion of the AI/ML data over the UP from the at least one second network entity; and wherein the third portion of the AI/ML data includes one or more of an AI/ML trained model, AI/ML model construction, AI/ML model topology, neural network weights, datasets for training, or measurements and statistics for model training.

According to various examples, the at least one processor is configured to: establish a second connection between the first AI/ML data transfer function and at least one third AI/ML data transfer function included in the network; and the at least one third AI/ML data transfer function is included at a third network entity; and wherein the first network entity is a user equipment (UE), the at least one second network entity comprises at least one user plane function (UPF), and the third network entity is a next generation node B (gNB) or next generation radio access network (NG-RAN).

According to various examples, the first network entity is a user plane function (UPF).

According to various examples (e.g. such as when the first network entity is a UPF), the at least one processor is configured to: receive, from a session management function (SMF) or a policy control function (PCF in the network, the at least one rule or policy; and configure the first AI/ML data transfer function based on the received at least one rule or policy.

According to various examples (e.g. such as when the first network entity is a UPF), the at least one processor is configured to: allocate an IP address for the first AI/ML data transfer function; and transmit information on the IP address to a session management function (SMF) included in the network.

According to various examples, the first network entity is a next generation node B (gNB) or next generation radio access network (NG-RAN).

According to various examples (e.g. such as when the first network entity is a gNB or NG-RAN), the at least one second network entity is a user equipment (UE), and the first network entity is configured to interact with the UE over the UP via a data radio bearer; or wherein the at least one second network entity comprises at least one user plane function (UPF), and the first network entity is configured to interact with the at least one UPF over the UP via a new transport session over N3 interface.

According to various examples (e.g. such as when the first network entity is a UE, or a gNB or NG-RAN), the first AI/ML data transfer function is configured to receive, from the network, one or more measurement configuration and/or data collection instructions.

According to a second aspect of the present disclosure, there is provided a method of a first network entity comprising a first artificial intelligence (AI)/machine learning (ML) data transfer function and being included in a network, the method comprising: establishing a first connection between the first AI/ML data transfer function and at least one second AI/ML data transfer function included in the network; and controlling the first AI/ML data transfer function to coordinate communicating AI/ML data with the network over user plane (UP) or control plane (CP) based on at least one rule or policy, wherein the AI/ML data relates to an AI/ML operation; wherein each of the at least one second AI/ML data transfer function is included in a second network entity.

Other aspects, advantages, and salient features of the disclosure will become apparent to those skilled in the art from the following detailed description taken in conjunction with the accompanying drawings.

### Advantageous Effects of Invention

Aspects of the present disclosure provide efficient communication methods in a wireless communication system.

### BRIEF DESCRIPTION OF DRAWINGS

Embodiments/examples of the present disclosure are further described hereinafter with reference to the accompanying drawings, in which:

FIG. 1 illustrates a representation of 5G System Architecture according to various embodiments of the present disclosure;

FIG. 2 illustrates a representation of Non-Roaming 5G System Architecture according to various embodiments of the present disclosure;

FIG. 3 illustrates FL (federated learning) interactions according to various embodiments of the present disclosure;

FIG. 4 illustrates the relationship between performance gap and experience of learning with and without distribution of data collection/transfer according to various embodiments of the present disclosure;

FIG. 5 illustrates data transfer times according to various embodiments of the present disclosure;

FIG. 6 illustrates Non-Roaming and Roaming with Level Breakout architecture for ATSSS (access traffic steering, switching and splitting) support according to various embodiments of the present disclosure;

FIG. 7 illustrates a network architecture according to various embodiments of the present disclosure;

FIG. 8 illustrates a network architecture according to various embodiments of the present disclosure;

FIG. 9 is a block diagram illustrating an example structure of a network entity according to various embodiments of the present disclosure;

FIG. 10 is a flow diagram illustrating a method according to various examples of the present disclosure;

FIG. 11 is a block diagram of a terminal (or a user equipment (UE), according to embodiments of the present disclosure; and

FIG. 12 is a block diagram of a base station, according to embodiments of the present disclosure.

### BEST MODE FOR CARRYING OUT THE INVENTION

Accordingly, the embodiment herein is to provide a first network entity comprising a first artificial intelligence (AI)/machine learning (ML) data transfer function. The first network entity includes a transmitter, a receiver, and at least one processor. The processor is configured to establish a first connection between the first AI/ML data transfer function and at least one second AI/ML data transfer function included in the network, and control the first AI/ML data transfer function to coordinate communicating AI/ML data with the network over user plane (UP) or control plane (CP) based on at least one rule or policy. Further, the AI/ML data relates to an AI/ML operation, each of the at least one second AI/ML data transfer function is included in a second network entity.

In an embodiment, by the first network, the first AI/ML data transfer function is configured to control transfer of the AI/ML data over the UP or the CP based on data characteristics of the AI/ML data.

In an embodiment, by the first network, the first AI/ML data transfer function is connected to the at least one second AI/ML data transfer function via at least one existing or new protocol data unit (PDU) session.

In an embodiment, by the first network, the first connection is between the first AI/ML data transfer function and a plurality of the second AI/ML data transfer functions. Further, the at least one processor is configured to determine at least one transport protocol for use in establishing the first connection based on at least one of: a type of the AI/ML data, priority of the AI/ML, reliability and security of the transport protocol or available access in the case of multi-access scenarios, or receive, from the network, an indication of the at least one transport protocol.

In an embodiment, by the first network, one instance is used in the first connection for connecting the first AI/ML data transfer function to the plurality of second AI/ML data transfer functions or to a subset of the plurality of second AI/ML data transfer functions, over the at least one transport protocol.

In an embodiment, by the first network, the at least one transport protocol comprises a plurality of transport protocols. Further, the first AI/ML data transfer function is configured to simultaneously use multiple transport sessions, using the plurality of transport protocols, for coordinating communication of the AI/ML data.

In an embodiment, by the first network, different transport protocols among the plurality of transport protocols are used for communicating different types of AI/ML data.

In an embodiment, by the first network, the AI/ML data comprises a first AI/ML model and a second AI/ML model, wherein the first AI/ML model is a different type of AI/ML data to the second AI/ML model. Further, the first AI/ML data transfer function is configured to use a first transport protocol, among the plurality of transport protocols, for transmitting or receiving the first AI/ML model and use a second transport protocol, among the plurality of transport protocols. For transmitting or receiving the second AI/ML model, the second transport protocol is different to the first transport protocol.

In an embodiment, the first network entity is a user equipment (UE).

In an embodiment, by the first network, the at least one processor is configured to control the first AI/ML data transfer function to coordinate collection of at least a first portion of the AI/ML data; and transmit the first portion of the AI/ML data to the at least one second network entity based on the first connection.

In an embodiment, by the first network, the at least one processor is configured to transmit, to a core network (CN) during initial UE registration in the network, an indication that the first network entity includes the first AI/ML data transfer function or supports the first AI/ML data transfer function; and/or receive, from the CN, a PDU related message indicating that a PDU session corresponding to the PDU related message supports the first AI/ML data transfer function, wherein the PDU related message comprises an IP address of the at least one second AI/ML data transfer function, and the at least one existing or new PDU session is the indicated PDU session.

In an embodiment, by the first network, the at least one rule or policy are received from the network and indicates how measurements are to be configured at the first network entity, data to be collected by the first network entity and the frequency of the collection of the data, how at least a second portion of the AI/ML data is to be communicated by the first network entity, and/or a PDU session to be used for the AI/ML data, wherein the at least one existing or new PDU session is the indicated PDU session.

In an embodiment, by the first network, the at least one rule or policy indicates how to transmit the second portion of the AI/ML data based on one or more of a size of the AI/ML data, a type of the AI/ML data, a priority of the AI/ML data, or privacy of the AI/ML data.

In an embodiment, by the first network, the at least one rule or policy indicates how the AI/ML data is to be communicated, a priority for communicating the AI/ML data, and/or, if the at least one rule or policy comprises a plurality of different rules or policies, a relative priority between the plurality of different rules or policies.

In an embodiment, by the first network, the at least one rule or policy is received from the network; and/or the at least one rule or policy indicates, for each of a plurality of different network conditions, how the AI/ML data is to be communicated and/or the priority for communicating the AI/ML data.

In an embodiment, by the first network, the at least one rule or policy comprises the plurality of different rules or policies, and the plurality of different rules or policies originate from a plurality of different entities within the network and the relative priority between the plurality of different rules or policies indicates whether a rule or policy, among the plurality of different rules or policies, originating from one of the plurality of different entities can be prioritised over another rule or policy, among the plurality of different rules or policies, originating from a different one of the plurality of different entities.

In an embodiment, by the first network, the at least one processor is configured to receive at least a third portion of the AI/ML data over the UP from the at least one second network entity and the third portion of the AI/ML data includes one or more of an AI/ML trained model, AI/ML model construction, AI/ML model topology, neural network weights, datasets for training, or measurements and statistics for model training.

In an embodiment, by the first network, the at least one processor is configured to establish a second connection between the first AI/ML data transfer function and at least one third AI/ML data transfer function included in the network and the at least one third AI/ML data transfer function is included at a third network entity. Further, the first network entity is a user equipment (UE), the at least one second network entity comprises at least one user plane function (UPF), and the third network entity is a next generation node B (gNB) or next generation radio access network (NG-RAN).

In an embodiment, by the first network, the at least one processor is configured to receive, from a session management function (SMF) or a policy control function (PCF) in the network, the at least one rule or policy and configure the first AI/ML data transfer function based on the received at least one rule or policy.

In an embodiment, by the first network, the at least one processor is configured to allocate an IP address for the first AI/ML data transfer function and transmit information on the IP address to a session management function (SMF) included in the network.

In an embodiment, by the first network, the at least one second network entity is a user equipment (UE), and the first network entity is configured to interact with the UE over the UP via a data radio bearer. Further, the at least one second network entity comprises at least one user plane function (UPF), and the first network entity is configured to interact with the at least one UPF over the UP via a new transport session over N3 interface.

Accordingly, the embodiment herein is to provide a method of a first network entity comprising a first artificial intelligence (AI)/machine learning (ML) data transfer function and being included in a network. The method includes establishing a first connection between the first AI/ML data transfer function and at least one second AI/ML data transfer function included in the network, and controlling the first AI/ML data transfer function to coordinate communicating AI/ML data with the network over user plane (UP) or control plane (CP) based on at least one rule or policy, wherein the AI/ML data relates to an AI/ML operation. Further, each of the at least one second AI/ML data transfer function is included in a second network entity.

### MODE FOR THE INVENTION

The following description of examples of the present disclosure, with reference to the accompanying drawings, is provided to assist in a comprehensive understanding of certain examples of the present disclosure. The description includes various specific details to assist in that understanding but these are to be regarded as merely exemplary. Accordingly, those of ordinary skill in the art will recognize that various changes and modifications of the examples described herein can be made without departing from the scope of the invention or disclosure.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the disclosure.

Throughout the description of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description of this specification, the singular form, for example “a”, “an” and “the”, encompasses the plural unless the context otherwise requires. For example, reference to “an object” includes reference to one or more of such objects.

Throughout the description, the expression “at least one of A, B and/or C” (or the like), the expression “and/or”, and the expression “one or more of A, B and/or C” (or the like) should be seen to separately include all possible combinations, for example: A, B, C, A and B, A and C, A and B and C.

Throughout the description of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment or example are to be understood to be applicable to any other aspect, embodiment or example described herein unless incompatible therewith.

Certain examples of the present disclosure provide methods, apparatus and/or systems for transferring (e.g., delivering and/or collecting) AI/ML related data in a network. Various examples provide methods, apparatus and/or systems wherein a new network function is provided in one or more network entities, with this network function being responsible for delivering AI/ML models and/or related data, and optionally for collecting data for AI/ML purposes also. In various examples, the new network function is a AI data delivery function provided in a UE and in a user plane function (and, optionally, in a RAN) to provide AI/ML related data to the UE over the UP.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard. For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. In particular, the following disclosure should be considered in relation to 6G also, which is expected to use at least part of the 5G architecture, or equivalent, and to which the present disclosure also relates.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present disclosure is not limited to the specific examples disclosed herein. For example:
The techniques disclosed herein are not limited to 3GPP 5G, B5G or 6G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, example and/or embodiment disclosed herein. Certain embodiments of the present disclosure provide a machine-readable storage storing such a program.

A network according to one or more of the examples disclosed herein may include one or more of a Network Data Analytics Function (NWDAF) entity, an Access and Mobility Management Function (AMF) entity, a Session Management Function (SMF) entity, a Network Slice Selection Function (NSSF) entity, a Network Repository Function (NRF) entity, Application Function (AF) entity, and an Operation and Maintenance (OAM) entity. The network may include one or more Service Consumers (including one or more of the entities mentioned above and/or one or more other entities) that receive analytics from NWDAF. The skilled person will appreciate that a network may omit one or more of the entities mentioned above and/or may comprise one or more additional entities

As described above, Sync-FL may be computationally intensive for a network entity or participant (e.g., a UE). Sync-FL is an example which highlights the importance of minimizing partial or total disturbance of data collection and/or data transfer for AI/ML operations. Another important scenario could be related to multi-agent, multidevice ML operations where typically a big data processing task (e.g., distributed training) is split among a set of devices (UEs) by ML agents.

The content of the following documents is referred to below and/or their content provides background information that the following disclosure should be considered in the context of:
[1] 3GPP TS 22.261-Service requirements for the 5G system, SA1, Release 18 (e.g., V18.9.0), Release 19 (e.g., V19.2.0).
[2] 3GPP TS 23.501-System architecture for the 5G System (5GS), Release 18 (e.g. V18.0.0, V18.1.0).
[3] 3GPP TR 22.874-5G System (5GS); Study on traffic characteristics and performance requirements for AI/ML model transfer, Release 18 (e.g., V18.2.0).
[4] 3GPP TS 24.193-5G System; Access Traffic Steering, Switching and Splitting (ATSSS), Release 18 (e.g., V18.1.0).
[5] 3GPP TSG RAN Meeting #96, RP-221348.
[6] 3GPP TSG-RAN WG2 Meeting #121—Chairman notes (MediaTek).

Note: the indicated version numbers are provided for illustrative purposes, other (including future) versions of these documents are considered also.

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fourth Generation (4G) and Fifth Generation (5G) systems are now widely deployed, while beyond 5G (B5G) and 6G systems are being considered.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies B5G systems, such as 6G, are currently being considered and developed, and are expected to at least partly build on 5G systems.

A key innovation in 5G system architecture compared to EPC is the introduction of Service-Based Architecture (SBA). With SBA, every network function (NF) in 5G Core (5GC), such as Access and Mobility Management Function (AMF), Session Management Function (SMF), Unified Data Manager (UDM), Policy Control Function (PCF), etc., can communicate with another network function via RESTful application programming interfaces (APIs) over an HTTP protocol. A transport protocol (e.g., TCP, UDP, SCTP, etc.) should be utilized to carry HTTP payloads.

The SBA simplifies interactions between NFs given that interfaces can be defined at the application layer and they can be easily expandable. For example, if AMF wishes to interact with a newly proposed NF in 5GC, then this can be performed by a simple software update.

With SBA, each network function expresses its functionalities through Service-Based Interfaces (SBIs), which include a set of services. Each service includes a set of service operations (e.g., a set of RESTful APIs). This way, an NF can be a service producer, and a set of other NFs can be a service consumer.

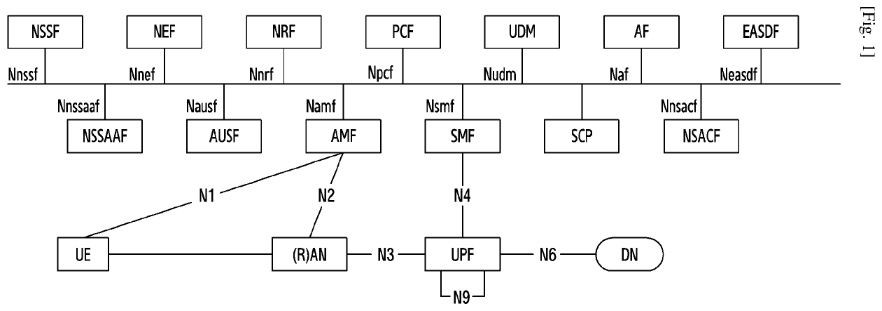

FIG. 1, from TS 23.501 [2] (Section 4.2.3), illustrates a high level architecture of 5GC (5G System Architecture) where several NFs are connected to one another via a bus. Typically, a Service Communication Proxy (SCP) governs communications between NFs in 5GC. SCP provides several benefits for 5GC networks such as load balancing, routing, message periodization, overload control, etc.

In FIG. 1, the interfaces N1, N2, N3, N4, and N6 do not support SBI while any interface name starts with “Nxx” support SBI (e.g., Npcf, Naf, Namf, etc.).

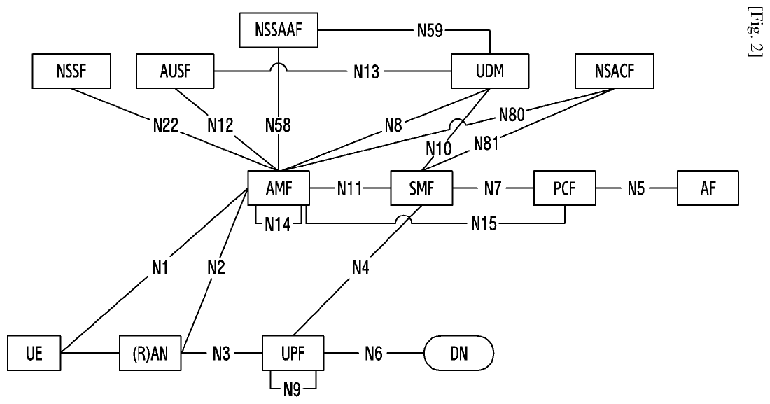

FIG. 2, from TS 23.501 [2] (Section 4.2.3), illustrates a non-roaming 5G system (5GS) architecture (Non-Roaming 5G System Architecture in reference point representation) with some key NFs interacting with one another. As it is clear, AMF is well connected to other NFs, given that it is an anchor point for relaying messages from NG-RAN and UE over N2 and N1 reference points, respectively. Similarly, SMF is also connected to several other NFs because it manages PDU sessions.

New frameworks and architectures are being developed as part of 5G network (and beyond, such as 6G networks) in order to increase the range of functionality and use cases available through 5G networks. One such new framework is the use of artificial intelligence (AI)/machine learning (ML), which may be used for the optimisation of the operation of 5G networks.

In AI/ML operation, AI/ML models and/or data might be transferred across the AI/ML applications (e.g., application functions (AFs)), 5GC (5G core), UEs (user equipments) etc.). Without limitation, the AI/ML works could be divided into two main phases: model training and inference. During model training and inference, multiple rounds of interaction may be required.

In Section 6.40 (‘AI/ML model transfer in 5GS’) in TS 22.261 [1], three types of AI/ML operations to be supported in (at least) Release 18 and Release 19 are described as follows:

### a) AI/ML Operation Splitting Between AI/ML Endpoints

The AI/ML operation/model is split into multiple parts according to the current task and environment. The intention is to offload the computation-intensive, energy-intensive parts to network endpoints, whereas leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.

### b) AI/ML Model/Data Distribution and Sharing Over 5G System

Multi-functional mobile terminals might need to switch the AI/ML model in response to task and environment variations. The condition of adaptive model selection is that the models to be selected are available for the mobile device. However, given the fact that the AI/ML models are becoming increasingly diverse, and with the limited storage resource in a UE, it can be determined to not pre-load all candidate AI/ML models on-board. Online model distribution (i.e. new model downloading) is needed, in which an AI/ML model can be distributed from a NW (network) endpoint to the devices when they need it to adapt to the changed AI/ML tasks and environments. For this purpose, the model performance at the UE needs to be monitored constantly.

### c) Distributed/Federated Learning Over 5G System

The cloud server trains a global model by aggregating local models partially-trained by each end devices. Within each training iteration, a UE performs the training based on the model downloaded from the AI server using the local training data. Then the UE reports the interim training results to the cloud server via 5G UL channels. The server aggregates the interim training results from the UEs and updates the global model. The updated global model is then distributed back to the UEs and the UEs can perform the training for the next iteration.

In general, the AI/ML works can be divided into three main phases: model training, model transfer and inference. More specifically, with the introduction of federated learning, model transfer has become a crucial phase to successfully perform some AI/ML operations. Time spent for model training, inference and transmission of the AI/ML models and for output of the inference depend on computation and/or communication capabilities of participating nodes/components; hence, the time varies among different nodes/components.

### Federated Learning (FL)

Federated Learning, in more detail, is an important machine learning technique that allows a set of participants (e.g. UEs) to engage in distributed model training without exposing their own parameters (data) other than a set of weights to outside entities. It is predicted that FL will be significantly used in several 5G and/or 6G use cases and thus, it generates a significant amount of traffic on 5G/6G networks. Therefore, it is crucial to be handled gracefully within 3GPP networks.

FIG. 3 illustrates key interactions between the main entities involved in a distributed FL (federated learning) model training session. Participants can include a car, robot, smartphone, and/or drone and the central FL server may be located in a 5G or 6G cloud within or outside the 3GPP network. Note that a central FL server may be located in other locations such as RAN, 5GC and/or UE, especially in a hierarchical FL model.

A general working principle of FL model training is as follows:
Participants advertise their willingness to be part of a training session.
The FL server selects a set of participants to be part of the next training cycle based on a set of criteria that may be dynamically changed between training cycles.
The FL server then distributed the latest trained global model to selected participants.
Each participant then starts its local model training when it receives the global model and its related configurations. The local training may use a particular or locally available dataset or real environment parameters.
Each participant then sends the trained model to the FL server once its local training is completed (i.e., when the local model is converged and is stable).
The FL server then aggregates all locally trained models from participants, creating a new global model which can be further distributed between participants in the next round of training sessions.

### Synchronous Federated Learning (Sync-FL)

Synchronous Federated Learning is a form of FL where participants have a strict deadline for their local model training completion and also uploading the results to the central FL server. If a participant can't meet the deadline, its results (i.e., trained models) may be unused by the central FL server, wasting 3GPP resources across UE, RAN, and Core Network. On that basis, typically, the central FL server indicates these time constraints to participants so that we can adjust their compute and network resources accordingly. That said, completing local model training at UE is also computationally intensive and thus requires a significant amount of power which is an important resource, especially for mobile devices with limited battery capacity. Table 1 (Latency and user experienced UL/DL data rates for uncompressed FL), from TR 22.874 [3] (Section 7.1.6.1), shows an example of resource usage:

TABLE 1

| | | Maximum | User experienced | |
|---|---|---|---|---|
| | | latency | UL/DL data rate | |
| | | for trained | for trained | |
| | | gradient | gradient | |
| Mini- | GPU | uploading | uploading and | |
| batch | computation | and global | global model | |
| size | time | model distribution | distribution | |
| (images) | (ms) | (see note 1) | (see note 2) | |
| 64 | 325 | 3.24 s | 325 | Mbit/s |
| 32 | 191 | 1.9 s | 55 | Mbit/s |
| 16 | 131 | 1.3 s | 810 | Mbit/s |
| 8 | 111 | 1.1 s | 960 | Mbit/s |
| 4 | 105 | 1.04 s | 1.0 | Gbit/s |

NOTE 1:
Latency in this table is assumed 20 times the device GPU computation time for the given mini-batch size.
NOTE 2:
Values provided in the table are calculative needs for an 8-bit VGG16 BN model with 132 MByte size, given mini-batch sizes and a duration of seconds per iteration. Necessary user experience UL/DL data rates can be reduced by e.g. setting longer times per iteration, applying compressed FL, or using another AI/ML model.

Accordingly, ways of using resources more efficiently are sought after.

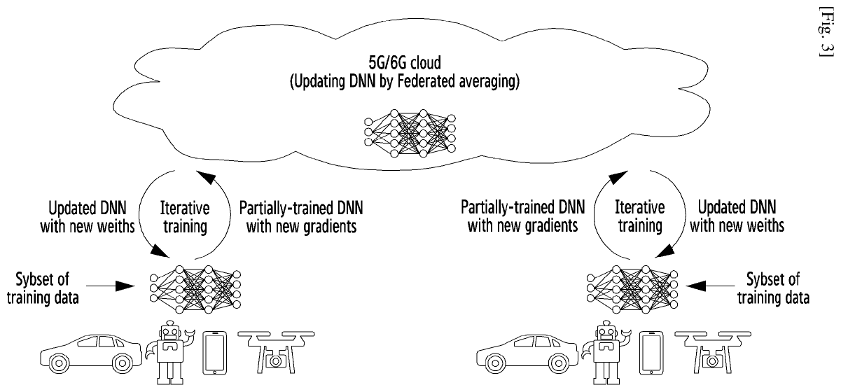

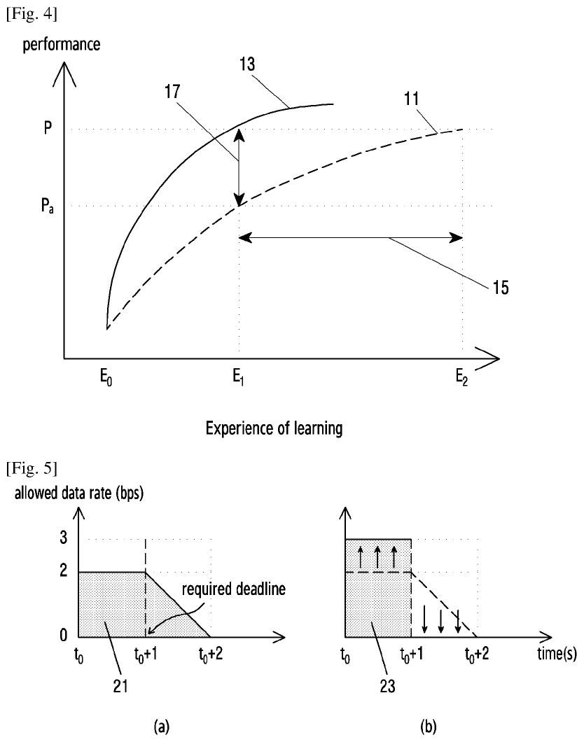

FIG. 4 (Performance gap vs. experience of learning for a given task: (1) with disturbance (e.g. delay) of data collection/transfer (dashed line 11) (2) without disturbance (e.g. delay) of data collection/transfer (solid line 13)), from TR 22.874 [3] (Section 7.3.1), illustrates the achievable learning performance (i.e., Experience of Learning) towards a given task when data collection/transfer is distributed (dashed line 11) and not (solid line 13). When AI/ML data (training results) is disturbed for any reason (and thus not arriving on time to its destination), it will directly influence on learning performance (the vertical line 17 and the horizontal line 15 between dashed line 11 and solid line 13 shows this performance gap).

There may be several reasons that the AI/ML data (training results, etc.) may be disturbed and thus will not be arrived at its destination on time. For example, these reasons may include one or more of the following:
Lack of network resources (e.g., radio resources due to temporal degradation, higher noise/interference level, highly crowded situations, partial/total break-down, etc.) preventing input data from being delivered in time.
Lack of computational resources at UE (e.g., GPU/CPU) at the time of training.
Lack of reach training dataset at UE.
Lack of power at UE during the course of the training.

FIG. 5, from TR 22.874 [3] (Section 7.3.1), illustrates a scenario where a UE attempts to prevent data disturbance by intelligently scheduling the UL data transmission for a particular set of bits so that the required UL data transmission deadline of one second is met. In particular, FIG. 5 illustrates an example of disturbance of data transfer within a preferred deadline of 1 sec (t=t0+1) with the data size of 3 bits: (a) it takes 2 seconds with “imperfect scheduling” to deliver the 3-bit data (“trapezoid” 21) (b) it takes 1 second with “good scheduling” to deliver the 3-bit data where the network resources can be assigned to others (other UEs) during (t0+1, t0+2).

In more detail, in FIG. 5(a), the UE delivered the relevant data with a size of 3 bits in two seconds as represented by data transfer 21, which caused the UL transmission deadline of one second to be missed. Whereas, in FIG. 5(b), the UE used a higher data rate of 3 bps, delivering the concerning data in one second (meeting the UL transmission deadline of one second) as represented by data transfer 23. This way, not only can the UE meet its application requirements but also, between time t₀+1 and t₀+2, the base station (e.g. gNB) has more resources to grant to other UEs for their UL transmission.

### Performance Measurement Function (PMF)

To support the ATSSS (Access Traffic Steering, Switching and Splitting) feature, described in TS 24.193 [4], the 5GS Architecture is extended, as shown in FIG. 6. FIG. 6, from TS 23.501 [2] (Section 4.2.10), illustrates non-roaming and roaming with local breakout architecture for ATSSS support.

A UE may support two steering functionalities in this architecture: (1) MPTCP (MultiPath-TCP) and/or (2) ATSSS-LL. Each steering functionality mentioned above enables traffic steering, switching and splitting across 3GPP access and non-3GPP access following the ATSSS rules provided by the network, specifically PCF (Policy Control Function)/SMF (Session Management Function).

The MPTCP Proxy functionality may be supported by UPF. The UPF can then communicate with the MPTCP functionality in the UE by using MultiPath-TCP (MPTCP) (IETF RFC 8684). Additionally, the UPF may support Performance Measurement Functionality (PMF), which the UE can use to obtain access performance measurements over the UP of 3GPP and non-3GPP accesses.

As part of 3GPP work on AI/ML for NR air interface (see [5]), RAN2 working group agreed to study the following potential solutions for AI/ML model transfer/delivery (from [6]):

| | |
|---|---|
| ⇒ | Agreed: |
| | Aim to at least analyze the feasibility |
| | and benefits of model/transfer |
| | solutions based on the following: |
| | Solution 1a: gNB can transfer/deliver AI/ML |
| | model(s) to UE via RRC signalling. |
| | Solution 2a: CN (except LMF) can transfer/deliver |
| | AI/ML model(s) to UE via NAS signalling. |
| | Solution 3a: LMF can transfer/deliver AI/ML |
| | model(s) to UE via LPP signalling. |
| | Solution 1b: gNB can transfer/deliver AI/ML |
| | model(s) to UE via UP data. |
| | Solution 2b: CN (except LMF) can transfer/deliver |
| | AI/ML model(s) to UE via UP data. |
| | Solution 3b: LMF can transfer/deliver AI/ML |
| | model(s) to UE via UP data. |
| | Solution 4: Server (e.g. OAM, OTT) can |
| | transfer/delivery AI/ML model(s) to UE |
| | (e.g. transparent to 3GPP). |

The 3GPP system is moving towards a fully automated system where AI/ML techniques play a crucial role. Currently, as part of Release 18 and 19, 3GPP is discussing potential use cases where AI/ML techniques can improve the 3GPP system performance significantly. For example, RAN1 and RAN2 working groups are currently discussing a few use cases in which AI/ML approaches could be an asset for improving the air interface performance, e.g., in CSI feedback, beam management, and location services. However, these few use cases are just the beginning of using AI/ML for the air interface. More 3GPP system functionality will be dependent on AI/ML techniques in the near future (not only for the air interface but generally for the entire 3GPP system, including UE, RAN, and CN).

However, the 5G control plane architecture is not currently designed to handle control messages which are very large in size, that is the case with AI/ML-related data, including neural network (NN) models, datasets, and large data collections. The current 5G control plane is designed (both in CN and RAN) for handling small and high-priority messages. For example, RRC signaling cannot handle (or has difficulties in handling) large data transfers, which also impacts NAS-based solutions. Even if control plane (CP) supports such data transfers, large transfers may impact small high-priority messages if these two types of traffic compete for the shared resources.

If AI/ML techniques are intended to be an integral part of the 3GPP system, an architectural modification to the current 5G system is required to support such data transfers between the 3GPP system's entities, including UE, RAN, and Core Network.

A possible approach considered herein is to use user plane (UP) for handling large CP messages such as AI/ML-related data. However, the current 5G architecture does not support such data transfers over UP. For example, there is no direct UP path between UE and gNB and/or there is no mechanism to use the N3 tunnel to exchange non-user data (e.g., AI/ML-related data) between UE and CN, and also between RAN and CN.

Accordingly, embodiments or examples of the present disclosure are provided in consideration of (e.g., with an aim to solving) one or more of the following problems:
How to deliver large AIML models and/or related data via the UP between UE and gNB.
How to deliver large AIML models and/or related data via the UP between UE and CN (e.g. UPF).
How to deliver large AIML models and/or related data via the UP between RAN (e.g., gNB) and UPF.
Which entities in the UE and/or gNB and/or CN should take responsibility of transferring/delivering AIML-related data, in the case of UP and CP.
How an AI/ML trained model by the network (e.g. gNB) can be delivered to UE via CN over UP, and which entity in CN should receive it and relay to UE.
If gNB intends to deliver AI/ML data (including model, training, dataset, and others) to UE, which 3GPP entities should decide on the priority of this transmission.
If AI/ML models could be transferred to UE in multiple ways simultaneously who should decide which one to choose.

Herein, it should be noted that AI/ML data or related data could be related to AI/ML model construction, AI/ML model topology, neural network weights, datasets for training, measurements and statistics for model training, and/or any other data which can be used by AI/ML components and/or other components handling AI/ML aspects (or traffic). Additionally, it should be noted that the examples, embodiments etc. disclosed herein could also be used for non-AI/ML use cases.

According to various examples of the present disclosure, there is provided a method of AI/ML model delivery over the user plane between CN and UE.

In such examples, a new network function (or new network entity) is added to both the UPF and the UE. This new NF may be referred to as “AI Data Delivery Function” (AI-DDF), though it will be appreciated that this name is not limiting and that other names may be given to the new NF which provides the functionality described herein. The AI-DDF may not only can take responsibility for delivering AI/ML models and/or related data over UP from CN to UE (and vice-versa), but the AI-DDF may also be configured to take responsibility for data collection for AI/ML purposes.

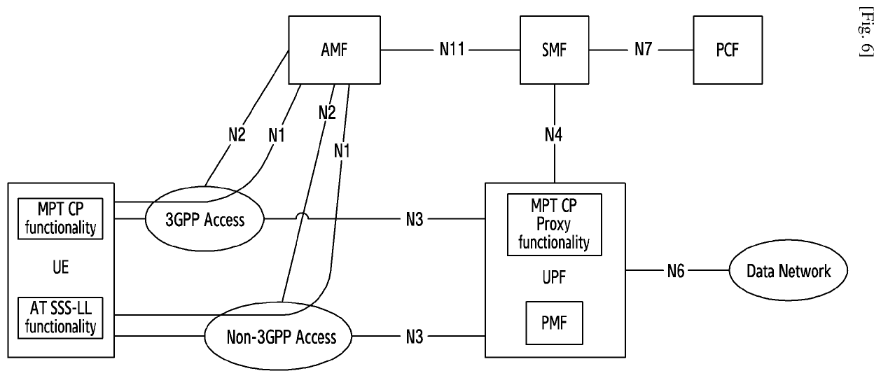

FIG. 7 illustrates a representation of network architecture in which AI-DDF is provided/integrated. According to various examples, with AI-DDF provided in the network (for example, in accordance with the below), any AI/ML data with potentially different sizes can be delivered between UE and CN with no issue. Although the system architecture at least partly reflects 5G system architecture, it will be appreciated that it may be extended to a B5G or 6G system.

FIG. 7 illustrates a UE 100, UPF 200, RAN 300, DN 400, 5GC 500 (including a number of NFs) and a PDU session 600 (e.g., established between UE 100 and UPF 200). UE 100 includes AI-DDF 110 and UPF 200 includes AI-DDF 210, thereby implementing the new NF mentioned above. Also shown in FIG. 7 are the various interfaces between different entities, including N1 710, N2 720, N3 730, N4 740, Uu 750, N6 760.

Note that each entity indicated in FIG. 7 may comprise one or more such entity. For example, UPF 200 may represent a single UPF or a plurality of UPFs. Additionally, reference to an AI-DDF may refer to an AI-DDF at one network entity (e.g., either AI-DDF 110, or AI-DDF 210 in the example of FIG. 7), to a plurality of AI-DDFs at the same network entity (e.g., in a case where multiple AI-DDFs are implemented at UE 100, UPF 200 or elsewhere), or to AI-DDFs across different network entities (e.g., both AI-DDF 110 and AI-DDF 210, each of which may also comprise, or refer to, multiple AI-DDFs).

Accordingly, FIG. 7 illustrates 5G architecture with the inclusion of the new AI-DDF component at both the UPF 200 and the UE 100. According to various examples, the AI-DDF is provided in a UE 100 and in the CN (e.g., in UPF 200). According to various examples, the AI-DDF components 110, 220 connect to each other via an existing PDU Session (e.g., as may be represented by PDU session 600) or a new PDU dedicated PDU Session (e.g., as may be represented by PDU session 600). According to an example, multiple instances of AI-DDF exist in the network (e.g., in UPF 200) connecting to the single instance at UE.

In one example, the AI/ML data is delivered between the UE 100 and CN entity (or entities), without the need for segmentation (an issue that exists with CP-based solutions), given that it is transferred over UP.

In another example, the AI-DDF is configured to assign a different priority to data transmission of different AI/ML models (e.g., if an AI/ML model has a large size and it is not time-sensitive, then it can be delivered over a path with low priority, i.e., a low priority QFI can be assigned).

According to various examples, the AI-DDF (e.g. AI-DDF 110 and/or AI-DDF 210) is implemented per PDU session (this way, e.g., multiple instances of AI-DDF may need to be established within a single UPF 200). Alternatively, in other examples the AI-DDF is used over multiple PDU sessions terminated at the same UPF 200 where this function is activated. For example, one AI-DDF (e.g., AI-DDF 110, 210 implemented at UE 100 and UPF 200) is implemented for a plurality of PDU sessions terminated at UPF 200.

Furthermore, as mentioned above, the AI-DDF may operate over an existing PDU session or, alternatively, a dedicated PDU session may be established with an existing UPF. In a further example, a network slice could additionally (or alternatively) be allocated to the AI-DDF in a PDU session (e.g., PUD session 600).

In the case of a plurality of UPF(s) (e.g., represented by UPF 200 in FIG. 7) handling different PDU sessions for a UE (e.g., UE 100), the network (e.g., CN) should determine which UPF(s), and thus which AI-DDF, should be activated to undertake responsibility of AI/ML-related data delivery and collection.

In the case where a plurality of instances of the AI-DDF exist for a UE (e.g. UE 100) across different PDU sessions (e.g. at different UPFs), the UE may use only one instance connecting to the plurality of instances (or a subset thereof) over a transport protocol such as TCP, UDP, SCTP, or MPTCP. Accordingly, the UE may determine a transport protocol to use for the instance (e.g., for the AI-DDF at the UE connecting to AI-DDFs elsewhere, such as at UPF(s)). Alternatively, another network entity (e.g., the network) may make this determination and inform the UE of the selected transport protocol.

According to various examples, the choice of transport protocol (i.e., the determination) depends on at least one of: the type of data to be transported (e.g., neural network models, training datasets, collected measurements and statistics, data analytics), data priority (e.g., whether data to be transferred is high priority or low priority, as may be defined in the network), reliability and security (e.g., of each transport protocol), available access in the case of multi-access scenarios, etc. An AI-DDF (e.g., AI-DDF 110, 210) may use multiple transport sessions simultaneously using different transport protocols. The decision of which transport protocol may be used for which AI/ML data transport could be configured by the network.

In an example where the AI-DDF is also (or even alternatively) responsible for AI/ML data collection, the AI-DDF may need to coordinate data collection across different requests (e.g. across or from different NFs).

For example, in one example, an LMF and an NWDAF simultaneously train an offline AI/ML model to be used within an air interface (e.g. a gNB) and/or a UE. Here, data collection and measurement configurations may need to be configured (e.g. at the gNB and/or UE) in an optimal manner (e.g., not collecting the same information twice due to a different collection interval and deliver it over UP connections). In such cases, coordination with the network (e.g. gNB) may be needed where normal air interface measurements are configured (e.g., MDT, SON, RRM, RRC measurement reports, CSI, etc.). In other words, when the AI-DDF needs to undertake data collection functionality, then it requires to be coordinated with the network so that the network can configure different measurements and data collections within UE and gNB. For example, an AI-DDF (at the UE and/or gNB) receives, from the network, one or more measurement configurations and/or data collection instructions, to be used or implemented by the AI-DDF.

According to various examples, the AI-DDF (e.g., AI-DDF 110 and/or AI-DDF 210) is enabled during PDU Session Establishment or Modification procedures. For example, this can be signaled within the 5G-SM capability information element (IE) of PDU Session Establishment/Modification Request message (i.e., a PDU setup message) where a UE (e.g., UE 100) can express its supported capabilities and/or desired PDU session, for example, Reflective QoS, MH6-PDU, MA-PDU Session, etc.

In a further case, the UE may need to indicate its AI/ML data delivery capability (e.g., whether it supports AI-DDF) during initial UE registration to the network so that such functionality can be activated later on over PDU Session(s) if the UE has required permission to do use it. In this scenario, the NAS signaling may need to be extended. For example, the 5 GMM capability IE may be extended with a new AIML IE as part of the UE Registration Request message. In another example, the UE may indicate its support of AIML data delivery capability to the network based on a request from the network. Accordingly, in various examples the UE is configured to transmit, to the network, an indication that the UE supports AI-DDF (or an indication that the UE does not support AI-DDF). In further examples, this may be in response to a request (of whether the UE does or does not support AI-DDF) from the network.

In an embodiment, the network stores (or saves) the UE's support of AI/ML data delivery capability in the UE context. In other words, the network (e.g., a network entity in the network) may be configured to store, for one or more UEs, whether a respective UE of the one or more UEs supports (and/or does not support) AI-DDF or other AI/ML data delivery capability.

Considering now the configuration of the AI-DDF (e.g., AI-DDFF 110 and/or AI-DDF 210), the PCF (e.g., included in 5GC 500 in FIG. 7) may compile and send a set of rules to the UPF (e.g., UPF 200) (directly if UPF supports SBI (Service-Based Interface) or indirectly, e.g., via SMF if not) to configure the AI-DDF (e.g., AI-DDF 210). For example, this could be done during the PDU Session Establishment/Modification procedure (e.g., PDU session setup) or via DL NAS transport (over PS-Signaling).

In the case where a UPF does not support SBI (e.g., as in 3GPP Release 17), the PCF sends the set of rules to SMF first (e.g. via API(s), such as Npcf_SMPolicyControl APIs). The SMF then creates rules, e.g. N4 rules (including rules related to AI-DDF and, optionally, other rules such as PDR, FAR, URR, and/or QER, etc.), and pushes them to UPF.

In the case where a UPF supports SBI, PCF can send these rules to the UPF directly. However, in various examples the sending of the rules to the UPF may still be preferred to be done via SMF because the SMF, in general (as a session manager), may need to be aware of such rules/policies. This may be important given that SMF needs to select the UPF at this stage and thus, selecting a UPF which supports the AI-DDF is required.

SMF may already know (e.g. from or during PDU Session Establishment/Modification procedure) whether the UE has requested to activate the AI-DDF and also whether the UE's subscription is allowed such functionality (due to prior interactions with UDM). In other words, the UE may have transmitted a request to activate the AI-DDF, and the SMF may have identified that such a request has been transmitted. Furthermore, the SMF may identify whether the UE's subscription (e.g., in the network) allows for this functionality (e.g., activating the AI-DFF).

If the AI-DDF functionality is supported for a PDU session by the network and UE, the UPF (e.g., UPF 200) may allocate an IP address for the AI-DDF (e.g., AI-DFF 210), and send this information to SMF (e.g., during N4 session establishment). The SMF may send this information to AMF (e.g., via Namf_Communication_NIN2MessageTransfer message).

Thereafter, the AMF may send a PDU related message (e.g., the PDU Session Accept message) to the UE (e.g. via the NAS signaling) indicating to UE that this PDU session supports the AI-DDF. The IP address of the AI-DDF (e.g. AI-DFF 210) at the UPF (e.g., UPF 200) side is also provided in this message to UE. Optionally, this message may include rules related to AI-DDF for delivering AI/ML models and also data collection, etc.

In various examples, the rules and policies may indicate how different AI/ML models should be delivered and/or with what transmission priority under different network conditions (or in general), and/or how rules indicated by different network entities at different times should be prioritized over one another (e.g., whether NWDAF or LMF may overwrite one or more rules originally populated by PCF, in some conditions).

Similarly, SMF or PCF can compile and send a set of rules to UE (e.g., UE 100) for configuring AI-DDF (e.g., AI-DFF 110) at the UE side. These rules may be referred as “AI-DDF rules”, and may include: how measurements should be configured at UE and/or which data should be collected in what frequency, and/or how AI/ML data should delivered at the UL direction depending on one or more of the AI-ML data size, type, priority, privacy, etc. In various embodiments, these rules may be delivered to UE during PDU Session Establishment/Modification procedure (e.g., while setting up a PDU session), e.g., within a new IE in N1 SM Container.

In further examples, a set of USRP rules may also needed at UE so that when a particular AI/ML application traffic (e.g., related to model transfer) arrives at lower layer, the URSP rules determine which PDU session (i.e., which AI-DDF) should be used. Accordingly, the UE may receive a set of USRP rules and, based on the USRP rules, determine a PDU session or AI-DDF to be used for received AI/ML traffic (e.g. related to model transfer).

According to various examples of the present disclosure, methods and apparatus support model delivery (or data therefor) over user plane between RAN and CN/UE. That is, the concepts and features described in the examples, embodiments etc., above are also viable at another network entity, such as NG-RAN.

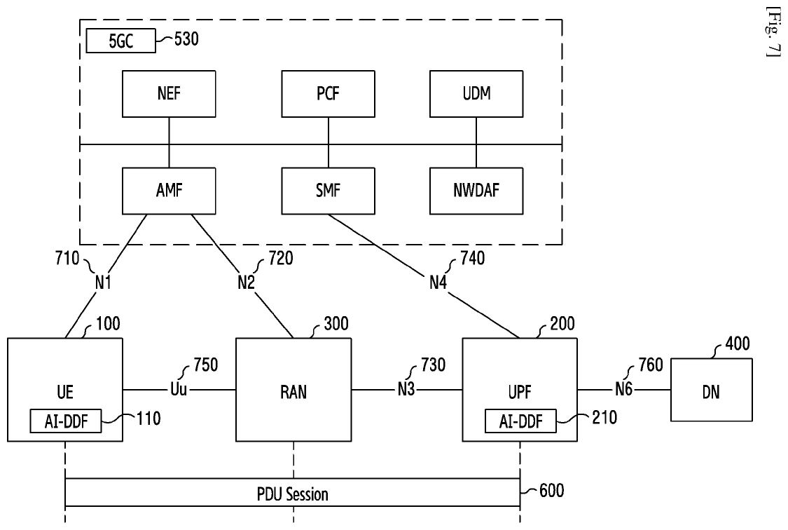

FIG. 8 illustrates a system architecture where, in addition to the features shown in FIG. 7, RAN 300 comprises AI-DDF 310. Although the system architecture at least partly reflects 5G system architecture, it will be appreciated that it may be extended to a B5G or 6G system. Furthermore, DRB 800 is established, or exists, between UE 100 and RAN 300, and an N3 tunnel 900 is established, or exists, between RAN 300 and UPF 200. As mentioned for FIG. 7, each entity indicated in FIG. 8 may comprise one or more such entity. For example, UPF 200 may represent a single UPF or a plurality of UPFs. Additionally, reference to an AI-DDF may refer to an AI-DDF at one network entity (e.g., either AI-DDF 110, AI-DDF 210 or AI-DDF 310, in the example of FIG. 8), to a plurality of AI-DDFs at the same network entity (e.g., in a case where multiple AI-DDFs are implemented at UE 100, UPF 200, RAN 300 or elsewhere), or to AI-DDFs across different network entities (e.g., two or more of AI-DDF 110, AI-DDF 210 and AI-DDF 310, each of which may also comprise, or refer to, multiple AI-DDFs).

Accordingly, FIG. 8 illustrates the AI-DDF 110, 210, 310 at the UE 100, RAN 300 (e.g., gNB) and CN (i.e., UPF 200). The AI-DDF 310 at RAN 300 (e.g. NG-RAN 300, or gNB) can connect to the UE 100 via a PDU-link session 600 over DRB 800 and connect to UPF 200 via the N3 tunnel 900. The AI-DDF (e.g., one or more of AI-DDF) 110, 210, 310 can deliver AI/ML-related data (including large models) over user plane.

According to an example in association with FIG. 8, AI-DDF can be activated per gNB (e.g., corresponding to RAN 300) where a new connection between gNB and UPF (e.g., UPF 200) can be established (e.g., over an existing N3 tunnel such as N3 tunnel 900).

The connection between gNB (or RAN 300) and UPF (e.g., UPF 200) is similar to the case of UE and UPF, where a new transport protocol can be used over the existing N3 tunnel. The choice of transport protocol (e.g., UDP, TCP, MPTCP) may be decided or determined (e.g., by the network, or by RAN 300) according to AI/ML data requirements (e.g., reliability, latency) and configuration of the associated DRB (e.g., DRB 800) (e.g., when RLC-AM is used, then UDP may be a good transport protocol while with RLC-UM, TCP could be used). This approach may work even in the case of the UE is in RRC_INACTIVE state, because, in that state, the N3 resources are still available between the gNB and UPF.

In an example, a similar session is established between the UE (e.g., UE 100) and gNB (or RAN 300), e.g., after the completion of a PDU Session Establishment procedure or after the UE has registered in a PLMN. In various examples, the AI-DDF (e.g., AI-DDF 310) at the gNB (or NG-RAN 300) is regarded as a special UPF delivering UP between the UE and gNB. This new session between the UE and gNB can be established during PDU Session Established/Modification procedure (e.g. required DRB (e.g., DRB 800) may be set up by RRC procedure, such as RRC Reconfiguration procedure), reusing the same security and integrity credentials of the related PDU session. The information regarding the IP address of the AI-DDF at gNB (e.g., AI-DDF 310) may be sent to UE, for example, via the NAS PDU Session Accept Message. In some cases, this approach only works when UE is in RRC_CONNECTED and thus all UP resources (e.g., DRBs) should be allocated between the UE and gNB.

According to the above disclosures, the UE 100 can interact with the gNB (or NG-RAN 300) over the data plane (via a DRB 800), and the gNB (or NG-RAN 300) can interact with UPF 200 over a new transport session over N3 (e.g., via N3 tunnel 900).

Some non-limiting examples of use cases for using UP between UE, RAN and CN are now provided.

In one example: an offline model is trained in CN (e.g., by NWDAF or LMF or in another newly added or existing network entity or function) and it should be delivered to the gNB, but the CP route cannot be used due to the large size of AI/ML data, which may cause congestion on the CP path to gNB, delaying important CP messages. Instead, according to examples in accordance with the present disclosure, the model can be delivered to UPF either indirectly, such as through SMF (e.g. via N4), or directly if UPF supports SBI. The AI-DDF at UPF may then deliver this to the AI-DDF component at the gNB (e.g., over N3 interface), where it will be delivered further to UE if needed (i.e. optionally delivered to AI-DDF at the UE), such as shown in FIG. 8.

In another example: the gNB trains an offline AI/ML model that should be used at a UE. In one case, the gNB could deliver it to UPF via a new AI-DDF session (between gNB and UPF over N3, for instance), and then the AI/ML model will be delivered to the UE via non-3GPP access, such as Wi-Fi, in the case of an MA-PDU session. Alternatively, in another case, the gNB may directly deliver this AI/ML related data to the UE over the UP connection between AI-DDF instances at UE and gNB.

In another example, the UE trains an offline AI/ML model, that should be used at a gNB. The UE may transport the trained model to UPF via WiFi access, such as in the case of the MA-PDU session (i.e., UP over non-3GPP access). The UPF may then deliver it to gNB over N3, as discussed earlier. This scenario may be advantageous when the UE does not have a good connection over 3GPP access (e.g., over Uu interface) but has a good connection over non-3GPP access (e.g., over WiFi), and the AI/ML model should be transported to gNB as soon as possible.

In another example, the UE trains an AI/ML model, which should be used at CN (e.g., LMF or NWDAF). The UE may initially transport the trained model to a gNB via UP over a low-priority DRB. From the gNB, the model can be delivered to UPF over N3 (via UP). From UPF (e.g., by AI-DDF) to its destination (e.g., LMF), the model may be delivered either directly over SBI or via N4. This way, the 5GC control plane is used minimally for transferring AI/ML data, which are typically very large and time-insensitive. In another example, the UE may transport the trained model to UPF (e.g. AI-DDF at UPF) via WiFi access in the case of the MA-PDU session. The UPF (AI-DDF) may then deliver it to LMF via N4 or directly if UPF supports SBI.

With regards to AI-DDF configurations by the network for a gNB, in one example: the network (e.g., PCF) pushes a set of one or more rules to gNB (e.g. AI-DDF at the gNB). To do so, the PCF initially pushes policy and charging control (PCC) rule(s) to SMF. The SMF may then create AI-DDF configurations or rules/policies configurations accordingly (e.g., based on the PCC rule(s)) and send them to AMF, e.g. via Namp_Communication API over non-ue-n2-messages transfer service operation. The AMF may then relay this to the gNB, e.g. over NGAP (NG application protocol). Optionally, the SMF may also transfer rules to gNB via Namf_Communication_NIN2MessageTransfer message, indicating some information needed to be parsed by gNB (the N2 part). The gNB then pushes those rules to the AI-DDF component (e.g., AI-DDF at the gNB) accordingly.

In various examples, if the N2 reference point supports SBI, such as may be the case in a B5G or 6G architecture, then the SMF directly pushes rules to gNB over HTTP. Otherwise, AMF will be used to relay messages between SMF and gNB (i.e AI-DDF at gNB). Direct interaction with AI-DDF may not be necessary at gNB and UPF by SMF, provided that the gNB and UPF act as a relay.

Various examples of the present disclosure relate to AI-DDF(s) determining whether to use CP or UP according to AI/ML data characteristics. For example, an AI-DDF (e.g., in or across UE, RAN or UPF) dynamically decides whether to use CP or UP for delivering particular AI/ML data. For example, if the data should be used for AI/ML inference purposes in an entity (e.g., UE, RAN, CN), then the AI-DDF uses the UP path with high-priority QoS flow or a CP path. Similarly, if the AI/ML data is time-insensitive, e.g., when delivering an offline trained model, then the AI-DDF may determine to use UP paths. It is important to note that every AI-DDF instance may determine how to deliver AI/ML data to the next node (this may be according to a policy provided by the network and/or one or more analytics that AI-DDF may collect from the network and UE). For example, the AI-DDF at the UE may initially determine to deliver AI/ML data to gNB via CP. But the AI-DDF at the gNB may determine to deliver (the) AI/ML data to an NF in 5GC via UPF (i.e., partially via UP) or directly via CP.

In various examples considered herein, the UE and gNB (i.e., RAN) may exchange AI/ML-related models and/or other AI/ML-related data via RRC signaling over an SRB (e.g., SRB4 or a new SRB with a particular priority depending on the AI/ML data size and latency requirements, assuming that the problem of RRC segmentation is resolved). However, this does not imply UP paths between gNB and UPF and also between UE and UPF are not required. For example, assume that UE wants to send an offline trained model to NWDAF or other NFs in 5GC (e.g., 5GC 500 in FIG. 7 or FIG. 8). The UE may initially use RRC signaling to carry the model to gNB over the Uu interface (this may also be a valid case when the UE is in RRC_INACTIVE and wishes to be in that state due to a lack of battery resource, for example). However, from gNB, instead of the model being delivered to AMF and from AMF to NWDAF/LMF, the model can be delivered to UPF (e.g., AI-DDF at UPF) over UP (passing through the N3 tunnel) and from UPF to NWDAF/LMF, directly if UPF supports SBI or via SMF (N4) otherwise. This way, the AMF, and CP, may not be a bottleneck by the large data size of AI/ML traffic. Instead, the CP of 5GC is partially being used by AI/ML traffic (e.g., between UPF and NWDAF/LMF if the UPF support SBI, which may be the case).

Accordingly, various examples, embodiments etc. in accordance with the present disclosure are provided in view of the considerations: using NGAP to transfer AI/ML-related data to CN from gNB may not be an optimal approach in several scenarios, especially when the data size is very large; transferring AI/ML-related data via NAS signaling between UE and CN may not be an optimal approach in several scenarios, especially when the data size is very large and not time-sensitive; and, in such scenarios, UP paths may be preferred for transporting AI/ML-related data.

According to an example of the present disclosure, there is provided a network comprising a first network entity (e.g., a UE) including a first data transfer component (e.g., at least one first AI-DDF) and a second network entity (e.g., a UPF) including a second data transfer component (e.g., at least one second AI-DDF), wherein: the first data transfer component is configured to receive AI/ML related data (or other data) from, or transmit AI/ML related data (or other data) to, the second data transfer component (e.g., via one or more PDU sessions or a network slice allocated to the first and second data transfer components in a PDU session).

According to an example, the first and/or second data transfer component is configured to obtain, from one or more network functions included in the network, the AI/ML related data (e.g., data for training a AI/ML model, information for configuring measurement of data for training an AI/ML model etc.).

According to an example, the first and/or second data transfer component is configured to receive, from the network, configuration information for obtaining the AI/ML related data; and, optionally, to obtain the AI/ML related data based on the configuration information.

According to an example, the first network entity is configured to indicate, to the network (e.g., during initial registration in the network), that the first network entity comprises or supports (or does not comprise or support) the first data transfer component. Optionally, this indication may be included in an IE transmitted to the network by the first network entity. Optionally, the indication is transmitted in response to a request, relating to whether the first network entity includes or supports the data transfer component, received form the network. Optionally, a third network entity in the network may be configured to store the indication from the first network entity.

According to an example, the second data transfer component is configured or activated in the second network entity in response to a message (e.g., instruction) received from the network.

According to an example, the first data transfer component and/or the second data transfer component determines whether to use a first communication method (e.g., communicating via control plane) or a second communication method (e.g., communicating via user plane) for transmitting specific AI/ML related data. For example, the determination may be based on a characteristic of the specific AI/ML related data (e.g., if the data is to be used for AI/ML inference, if the data is time-insensitive, a priority of the data etc.). According to a further example, at a later time, the first data transfer component and/or the second data transfer component may re-determine a communication method (e.g. the first communication method, the second communication method or another communication method) for transmitting specific AI/ML related data.

According to various examples of the present disclosure, there is provided a first network entity in accordance with any one or more of the above examples. According to various examples of the present disclosure, there is provided a second network entity in accordance with any one or more of the above examples.

According to various examples, the first data transfer component and/or the second data transfer are implemented in a single PDU session, or in a plurality of PDU sessions terminated at the second network entity.

According to various examples, the first data transfer component and/or the second data transfer are configured to operate over an existing PDU session or in a dedicated PDU session.

According to various examples, the second network entity is configured to receive, from a fourth network entity (e.g., PCF or SMF), one or more rules for configuring the second data transfer component. Optionally, the one or more rules are compiled by a fifth network entity (e.g., PCF) and transmitted to the second network entity via the fourth network entity (e.g., SMF). For example, in the event that the second network entity does not support SBI, the one or more rules compiled by the fifth network entity are received via the fourth network entity (e.g., SMF). In another example, regardless of whether or not the second network entity supports SBI, the one or more rules compiled by the fifth network entity are received via the fourth network entity (e.g., SMF).

According to various examples, the network further comprises a sixth network entity (e.g., RAN, or gNB) comprising a third data transfer component (e.g., third AI-DDL). The third data transfer component is configured to cooperate with at least one of the first data transfer component and the second data transfer component to exchange the AI/ML related data.

FIG. 9 is a block diagram of an exemplary apparatus, or network entity, that may be used in examples of the present disclosure. The skilled person will appreciate said entity may be implemented, for example, as a network element on a dedicated hardware, as a software instance running on a dedicated hardware, and/or as a virtualised function instantiated on an appropriate platform, e.g. on a cloud infrastructure.

The entity 1000 comprises a processor (or controller) 1001, a transmitter 1003 and a receiver 1005. The receiver 1005 is configured for receiving one or more messages from one or more other network entities, for example as described above. The transmitter 1003 is configured for transmitting one or more messages to one or more other network entities, for example as described above. The processor 1001 is configured for performing one or more operations, for example according to the operations as described above.

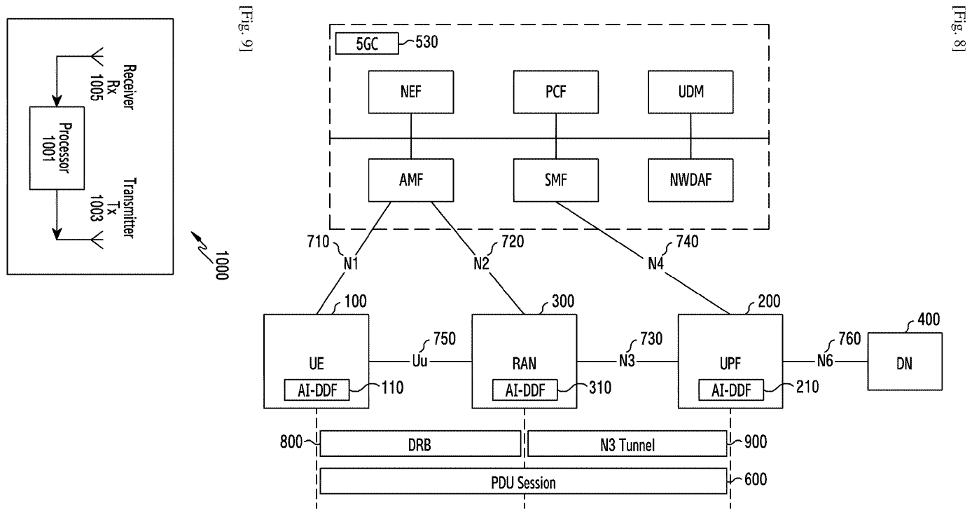

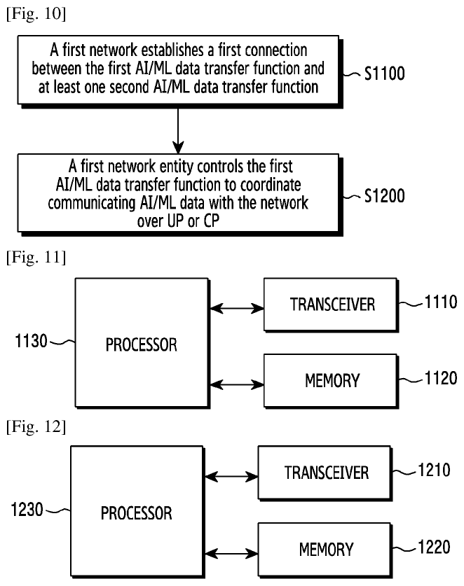

FIG. 10 is a flow diagram illustrating a method according to various examples of the present disclosure. The method is performed by a first network entity comprising a first artificial intelligence (AI)/machine learning (ML) data transfer function. The first network entity is included in a network. For example, the first network entity is a UE, a UPF or a gNB or NG-RAN.

In operation S1100, the first network entity establishes a first connection between the first AI/ML data transfer function and at least one second AI/ML data transfer function included in the network.

In operation S1200, the first network entity controls the first AI/ML data transfer function to coordinate communicating AI/ML data with the network over user plane (UP) or control plane (CP) based on at least one rule or policy, wherein the AI/ML data relates to an AI/ML operation. Each of the at least one second AI/ML data transfer function is included in a second network entity.

It will be appreciated that communicating AI/ML data (e.g. an AI/ML model) to a gNB as described herein (i.e. in any of the examples herein) may also be regarded as communicating the AI/ML data to an AI-DDF at the gNB, and vice versa. Similarly, it will be appreciated that communicating AI/ML data (e.g. an AI/ML model) to a UE as described herein may also be regarded as communicating the AI/ML data to an AI-DDF at the UE, and vice versa (and similar being the case for a UPF too).

It will be appreciated that, in each example/embodiment/aspect etc. described above, one or more features or operations may be omitted, modified or moved (e.g., to change the order of the features or the operations), if desired and appropriate. Additionally, one or more features or operations from any example/embodiment may be combined with features or operations from any other example/embodiment. In particular, regardless of whether or not a pointer towards a combination of features/examples is found herein, the present disclosure should be considered to include all combinations of two or more of the embodiments, examples etc. disclosed herein, and all combinations of two or more of the features disclosed herein.

The techniques described herein may be implemented using any suitably configured apparatus and/or system. Such an apparatus and/or system may be configured to perform a method according to any aspect, embodiment or example disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment and/or aspect disclosed herein, and/or a machine-readable storage storing such a program. Still further, such programs may be conveyed electronically via any medium, for example a communication signal carried over a wired or wireless connection.

While the present disclosure has been shown, illustrated and described with reference to certain examples, it will be understood by those skilled in the art that various changes in form and detail may be made therein without departing from the scope of the disclosure.

The reader's attention is directed to all papers and documents which are filed concurrently with or previous to this specification in connection with this application and which are open to public inspection with this specification, and the contents of all such papers and documents are incorporated herein by reference.

FIG. 12 illustrates a block diagram of a terminal (or a user equipment (UE)), according to embodiments of the present disclosure. FIG. 12 corresponds to the example of the UE of FIG. 1.

As shown in FIG. 12, the UE according to an embodiment may include a transceiver 1210, a memory 1220, and a processor 1230. The transceiver 1210, the memory 1220, and the processor 1230 of the UE may operate according to a communication method of the UE described above. However, the components of the UE are not limited thereto. For example, the UE may include more or fewer components than those described above. In addition, the processor 1230, the transceiver 1210, and the memory 1220 may be implemented as a single chip. Also, the processor 1230 may include at least one processor.

The transceiver 1210 collectively refers to a UE receiver and a UE transmitter, and may transmit/receive a signal to/from a base station or a network entity. The signal transmitted or received to or from the base station or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the UE. Also, the memory 1220 may store control information or data included in a signal obtained by the UE. The memory 1220 may be a storage medium, such as read-only memory (ROM), random access memory (RAM), a hard disk, a CD-ROM, and a DVD, or a combination of storage media.

The processor 1230 may control a series of processes such that the UE operates as described above. For example, the transceiver 1210 may receive a data signal including a control signal transmitted by the base station or the network entity, and the processor 1230 may determine a result of receiving the control signal and the data signal transmitted by the base station or the network entity.

FIG. 13 illustrates a block diagram of a base station, according to embodiments of the present disclosure. FIG. 13 corresponds to the example of the RAN of FIG. 1.

As shown in FIG. 13, the base station according to an embodiment may include a transceiver 1310, a memory 1320, and a processor 1330. The transceiver 1310, the memory 1320, and the processor 1330 of the base station may operate according to a communication method of the base station described above. However, the components of the base station are not limited thereto. For example, the base station may include more or fewer components than those described above. In addition, the processor 1330, the transceiver 1310, and the memory 1320 may be implemented as a single chip. Also, the processor 1330 may include at least one processor.

The transceiver 1310 collectively refers to a base station receiver and a base station transmitter, and may transmit/receive a signal to/from a terminal or a network entity. The signal transmitted or received to or from the terminal or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the base station. Also, the memory 1320 may store control information or data included in a signal obtained by the base station. The memory 1320 may be a storage medium, such as read-only memory (ROM), random access memory (RAM), a hard disk, a CD-ROM, and a DVD, or a combination of storage media.

The processor 1330 may control a series of processes such that the base station operates as described above. For example, the transceiver v10 may receive a data signal including a control signal transmitted by the terminal, and the processor 1330 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject

Acronyms and Definitions (as may be used herein)

| | |
|---|---|
| 3GPP | 3^{rd} Generation Partnership Project |
| 5G | 5^{th} Generation |
| 5GC | 5G Core |
| 5QI | 5G QoS Identifier |
| 5GS | 5G System |
| 5GSM | 5G System Session Management |
| 5GMM | 5G System Mobility Management |
| AF | Application Function |
| AI | Artificial Intelligence |
| AIML | Artificial Intelligence/Machine |
| | Learning |
| AM | Acknowledged Mode |
| AMF | Access and Mobility Management |
| | Function |
| AS | Application Server |
| ASP | Application Service Provider |
| ATSSS | Access Traffic Steering Switching |
| | & Splitting |
| AUSF | Authentication Server Function |
| CDRX | Connected Mode Discontinuous |
| | Reception |
| CSI | Channel Status Information |
| DCAF | Data Collection Application |
| | Function |
| DNAI | Data Network Access Identifier |
| DNN | Data Network Name |
| DNS | Domain Name Server |
| DRB | Data Radio Bearer |
| eNB | Evolved Node B |
| FQDN | Fully Qualified Domain Name |
| GBR | Guaranteed Bit Rate |
| GMLC | Gateway Mobile Location Centre |
| gNB | Next generation Node B |
| GPSI | Generic Public Subscription |
| | Identifier |
| IAB | Integrated Access and Backhaul |
| ID | Identity/Identifier |
| IIoT | Industrial Internet of Things |
| IMEI | International Mobile Equipment |
| | Identities |
| IP | Internet Protocol |
| I-SMF | Intermediate SMF |
| LMF | Location Management Function |
| MA-PDU | Multiple Access PDU |
| ML | Machine Learning |
| MME | Mobility Management Entity |
| MN | Master Node |
| MNO | Mobile Network Operator |
| MPTCP | MultiPath TCP |
| MT | Mobile Termination |
| NAS | Non-Access Stratum |
| NEF | Network Exposure Function |
| NRF | Network Repository Function |
| NG-RAN | Next Generation Radio Access |
| | Network |
| NG-eNB | Next Generation eNB |
| NSA | Non-Standalone |
| NSSF | Network Slice Selection Function |
| NW | Network |
| NWDAF | Network Data Analytics Function |
| OS | Operating System |
| OSAPP | OS Application |
| PCF | Policy Control Function |
| PCC | Policy and Charging Control |
| PCO | Protocol Configuration Options |
| PDR | Packet Detection Rule |
| PDU | Protocol Data Unit |
| PMF | Performance Measurement Function |
| PSA | PDU session anchor |
| QFI | QoS Flow Identifier (ID) |
| QoE | Quality of Experience |
| QoS | Quality of Service |
| RACH | Random Access Channel |
| RAN | Radio Access Network |
| RAT | Radio Access Technology |
| RLC-AM | Radio Link Control Acknowledge |
| | Mode |
| RLC-UM | Radio Link Control Unacknowledge |
| | Mode |
| RSD | Route Selection Descriptor |
| SA | Standalone |
| SBA | Service-Based Architecture |
| SBI | Service-Based Interface |
| SCP | Service-Based Communication Proxy |
| SCTP | Stream Control Transmission |
| | Protocol |
| SDAP | Service Data Adaptation Protocol |
| SDU | Service Data Unit |
| SIM | Subscriber Identity Module |
| SLA | Service Level Agreement |
| SM | Session Management |
| SMF | Session Management Function |
| SN | Secondary Node |
| S-NSSAI | Single Network Slice Selection |
| | Assistance Information |
| SSB | Synchronization Signal Block |
| SSC | Session and Service Continuity |
| SUPI | Subscription Permanent Identifier |
| TAI | Tracking Area Identity |
| TE | Terminal Equipment |
| TM | Transparent Mode |
| TS | Technical Specification |
| UDM | Unified Data Manager |
| UDR | Unified Data Repository |
| UE | User Equipment |
| UL | Uplink |
| UM | Unacknowledged Mode |
| UP | User Plane |
| UPF | User Plane Function |
| URLLC | Ultra-Reliable and Low-Latency |
| | Communication |
| URSP | UE Route Selection Policy |
| XRM | Extended Reality and Media |

1. A first network entity comprising a first artificial intelligence (AI)/machine learning (ML) data transfer function in a wireless communication system, the first network entity comprising:
a transmitter;
a receiver; and
at least one processor configured to:
establish a first connection between the first AI/ML data transfer function and at least one second AI/ML data transfer function included in the network, and
control the first AI/ML data transfer function to coordinate communicating AI/ML data with the network over user plane (UP) or control plane (CP) based on at least one rule or policy, wherein the AI/ML data relates to an AI/ML operation,
wherein each of the at least one second AI/ML data transfer function is included in a second network entity.

2. The first network entity of claim 1, wherein the first AI/ML data transfer function is configured to control transfer of the AI/ML data over the UP or the CP based on data characteristics of the AI/ML data, wherein the first AI/ML data transfer function is connected to the at least one second AI/ML data transfer function via at least one existing or new protocol data unit (PDU) session.

3. The first network entity of claim 2, wherein the first connection is between the first AI/ML data transfer function and a plurality of the second AI/ML data transfer functions; and
wherein the at least one processor is configured to:
determine at least one transport protocol for use in establishing the first connection based on at least one of: a type of the AI/ML data, priority of the AI/ML, reliability and security of the transport protocol or available access in the case of multi-access scenarios; or
receive, from the network, an indication of the at least one transport protocol.

4. The first network entity of claim 3,
wherein one instance is used in the first connection for connecting the first AI/ML data transfer function to the plurality of second AI/ML data transfer functions or to a subset of the plurality of second AI/ML data transfer functions, over the at least one transport protocol,
wherein the at least one transport protocol comprises a plurality of transport protocols,
wherein the first AI/ML data transfer function is configured to simultaneously use multiple transport sessions, using the plurality of transport protocols, for coordinating communication of the AI/ML data, and
wherein different transport protocols among the plurality of transport protocols are used for communicating different types of AI/ML data.

5. The first network entity of claim 4, wherein the AI/ML data comprises a first AI/ML model and a second AI/ML model, wherein the first AI/ML model is a different type of AI/ML data to the second AI/ML model,
wherein the first AI/ML data transfer function is configured to:
use a first transport protocol, among the plurality of transport protocols,
for transmitting or receiving the first AI/ML model; and
use a second transport protocol, among the plurality of transport protocols, for transmitting or receiving the second AI/ML model,
wherein the second transport protocol is different to the first transport protocol.

6. The first network entity of claim 4,
wherein the at least one processor is configured to:
control the first AI/ML data transfer function to coordinate collection of at least a first portion of the AI/ML data; and
transmit the first portion of the AI/ML data to the at least one second network entity based on the first connection.

7. The first network entity of claim 6, wherein the at least one processor is configured to:
transmit, to a core network (CN) during initial UE registration in the network, an indication that the first network entity includes the first AI/ML data transfer function or supports the first AI/ML data transfer function; and/or
receive, from the CN, a PDU related message indicating that a PDU session corresponding to the PDU related message supports the first AI/ML data transfer function,
wherein the PDU related message comprises an IP address of the at least one second AI/ML data transfer function,
wherein the at least one existing or new PDU session is the indicated PDU session.

8. The first network entity of claim 7, wherein the at least one rule or policy are received from the network and indicates:
how measurements are to be configured at the first network entity,
data to be collected by the first network entity and the frequency of the collection of the data,
how at least a second portion of the AI/ML data is to be communicated by the first network entity, and/or
a PDU session to be used for the AI/ML data, wherein the at least one existing or new PDU session is the indicated PDU session,
wherein the at least one rule or policy indicates how to transmit the second portion of the AI/ML data based on one or more of a size of the AI/ML data, a type of the AI/ML data, a priority of the AI/ML data, or privacy of the AI/ML data.

9. The first network entity of claim 7, wherein the at least one rule or policy indicates:
how the AI/ML data is to be communicated,
a priority for communicating the AI/ML data, and/or,
if the at least one rule or policy comprises a plurality of different rules or policies, a relative priority between the plurality of different rules or policies,
wherein the at least one rule or policy is received from the network,
wherein the at least one rule or policy indicates, for each of a plurality of different network conditions, how the AI/ML data is to be communicated and/or the priority for communicating the AI/ML data.

10. The first network entity of claim 9,
wherein the at least one rule or policy comprises the plurality of different rules or policies, and the plurality of different rules or policies originate from a plurality of different entities within the network, and wherein the relative priority between the plurality of different rules or policies indicates whether a rule or policy, among the plurality of different rules or policies, originating from one of the plurality of different entities can be prioritised over another rule or policy, among the plurality of different rules or policies, originating from a different one of the plurality of different entities.

11. The first network entity of claim 10, wherein the at least one processor is configured to:
receive at least a third portion of the AI/ML data over the UP from the at least one second network entity,
wherein the third portion of the AI/ML data includes one or more of an AI/ML trained model, AI/ML model construction, AI/ML model topology, neural network weights, datasets for training, or measurements and statistics for model training.

12. The first network entity of claim 1, wherein the at least one processor is configured to:
establish a second connection between the first AI/ML data transfer function and at least one third AI/ML data transfer function included in the network;
receive, from a session management function (SMF) or a policy control function (PCF in the network, the at least one rule or policy; and
configure the first AI/ML data transfer function based on the received at least one rule or policy,
wherein the at least one third AI/ML data transfer function is included at a third network entity,
wherein the first network entity is a user equipment (UE), the at least one second network entity comprises at least one user plane function (UPF), and the third network entity is a next generation node B (gNB) or next generation radio access network (NG-RAN).

13. The first network entity of claim 12, wherein the at least one processor is configured to:
allocate an IP address for the first AI/ML data transfer function; and
transmit information on the IP address to a session management function (SMF) included in the network,
wherein the at least one second network entity is a user equipment (UE), and the first network entity is configured to interact with the UE over the UP via a data radio bearer, or
wherein the at least one second network entity comprises at least one user plane function (UPF), and the first network entity is configured to interact with the at least one UPF over the UP via a new transport session over N3 interface.

14. The first network entity of claim 7, wherein the first AI/ML data transfer function is configured to receive, from the network, one or more measurement configuration and/or data collection instructions.

15. A method performed by a first network entity comprising a first artificial intelligence (AI)/machine learning (ML) data transfer function and being included in a wireless communication system, the method comprising:
establishing a first connection between the first AI/ML data transfer function and at least one second AI/ML data transfer function included in the network; and
controlling the first AI/ML data transfer function to coordinate communicating AI/ML data with the network over user plane (UP) or control plane (CP) based on at least one rule or policy, wherein the AI/ML data relates to an AI/ML operation,
wherein each of the at least one second AI/ML data transfer function is included in a second network entity.
